(19) United States
(12) Patent Application Publication
(10) Pub. No.: US 2007/0177654 A1
(43) Pub. Date: Aug. 2, 2007

(54) Detecting signal carriers of multiple types of signals in radio frequency input for amplification

(76) Inventors: Vladimir Levitine, Mountainside, NJ (US); Vito Salluce, Fairfield, NJ (US); Thomas Joseph Schwork, Sparta, NJ (US)

Correspondence Address: WILLIAMS, MORGAN & AMERSON, 10333 RICHMOND, SUITE 1100, HOUSTON, TX, 77042, US

(21) Appl. No.: 11/343,731

(22) Filed: Jan. 31, 2006

(51) Int. Cl. H04B 1/00

(52) U.S. Cl. 375/130

(57) ABSTRACT

The present invention provides a method and an apparatus for detecting one or more of spread spectrum signals of two or more types having distinct statistical characteristics to identify a signal input to an amplifier having an input terminal. The method comprises determining a signal characteristic of the signal input to associate the one or more of spread spectrum signals with one of the two or more types in response to an indication of statistical characteristics associated with the one or more of spread spectrum signals at the input terminal of the amplifier. The method further comprises distinguishing between the one or more of spread spectrum signals of the two or more types based on the statistical characteristics associated therewith.

### FIELD OF THE INVENTION

This invention relates generally to telecommunications, and more particularly, to wireless communications.

### DESCRIPTION OF THE RELATED ART

Wireless communications systems or mobile telecommunication systems typically provide different types of services to various users or subscribers of wireless communication devices. The wireless communication devices may be mobile or fixed units and situated within a geographic region across one or more wireless networks. The users or subscribers of wireless communication devices, such as mobile stations (MSs) or access terminals or user equipment may constantly move within (and outside) particular wireless networks.

A wireless communications system generally includes one or more base stations (BSs) that can establish wireless communications links with mobile stations. Base stations may also be referred to as node-Bs or access networks. To form the wireless communications link between a mobile station and a base station, the mobile station accesses a list of available channels/carriers broadcast by the base station. To this end, a wireless communications system, such as a spread spectrum wireless communications system, may allow multiple users to transmit simultaneously within the same wideband radio channel, enabling a frequency re-use based on a spread spectrum technique.

A transmitter in a base station may include a signal detector, such as a Root Mean Square (RMS) based detector which detects average power of a radio frequency (RF) input for use with an amplifier. With this implementation, the amplifier may distinguish between voice and data at calibrated points. Likewise, a transmitter in a mobile station transmits signals using a power amplifier. The mobile station may receive a desired transmit output power from a base station. This desired output power may adjust the gain of the power amplifier in the transmitter for transmitting the signals.

However, if the RF input to the amplifier changes gradually, the amplifier cannot distinguish between changes in the voice and/or data signals. In this way, an amplifier that is initially optimized at a highest power level may consume more power even at lower power levels.

The RF input having an associated radio frequency power may include power associated with different signals, such as voice, high data rate (HDR), or both. The voice signals have a relatively low peak to average (PAR) ratio while the HDR signals or carriers change characteristics such as transition from an idle mode to a full data mode or stage somewhere in between. The idle mode for HDR has a considerably high peak to average (PAR) ratio

Since the peak to average (PAR) ratio of a transmitted waveform determines a bias point and power efficiency of the transmitted RF power for an amplifier, a signal detector may not maintain an optimized biasing condition of HDR and/or voice for a multi-carrier amplifier for changing different signal waveforms. By using an initial optimization of a multi-carrier amplifier at a maximum power before a change of the power level in a particular type of a spread spectrum signal and/or a change in the mix or combination of multiple types of spread spectrum signal carriers, a signal detector may provide reduced power efficiency and may increase spurious radio frequency emissions.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for detecting one or more of spread spectrum signals of two or more types having distinct statistical characteristics to identify a signal input to an amplifier having an input terminal. The method comprises determining a signal characteristic of the signal input to associate the one or more of spread spectrum signals with one of the two or more types in response to an indication of statistical characteristics associated with the one or more of spread spectrum signals at the input terminal of the amplifier. The method further comprises distinguishing between the one or more of spread spectrum signals of the two or more types based on the statistical characteristics associated therewith.

In another embodiment of the present invention, a signal detector is provided for use with an amplifier to amplify an incoming radio frequency input including at least one type of spread spectrum signal for voice and data. The signal detector comprises detection circuitry to identify at least two statistical characteristics of the at least one type of spread spectrum signal and detect frequency components of the incoming radio frequency input. The signal detector further comprises a detector coupled to the detection circuitry for determining an indication of a signal characteristic of the at least one type of spread spectrum signal based on the frequency components to distinguish between the voice and data.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a radio associated with a spread-spectrum cellular system to include a signal detector for use with a multi-carrier amplifier to amplify a wireless communication signal, according to one illustrative embodiment of the present invention;

FIG. 2 schematically depicts the signal detector shown in FIG. 1 to distinguish between at least two types of carriers or two types of spread spectrum signals at varying transmit power level on one or more carriers such that a carrier may carry voice and/or data, in accordance with one illustrative embodiment of the present invention;

FIG. 3 illustrates a stylized representation for implementing a method of detecting one or more of spread spectrum signals of first and second types to identify a signal input for an amplifier, in accordance with one illustrative embodiment of the present invention; and

FIG. 4 illustrates a stylized representation for implementing a method of distinguishing between at least two types of carriers or two types of spread spectrum signals at varying transmit power level on one or more carriers, in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for for detecting one or more of spread spectrum signals of two or more types having distinct statistical characteristics to identify a signal input to an amplifier having an input terminal. The method comprises determining a signal characteristic of the signal input to associate the one or more of spread spectrum signals with one of the two or more types in response to an indication of statistical characteristics associated with the one or more of spread spectrum signals at the input terminal of the amplifier. The method further comprises distinguishing between the one or more of spread spectrum signals of the two or more types based on the statistical characteristics associated therewith. To distinguish at least two types of carriers or two types of spread spectrum signals at varying transmit power level on one or more carriers such that a carrier may carry voice and/or data for a multi-carrier amplifier, a signal detector may detect one or more of spread spectrum signals of first and second types to identify a signal input for optimizing the amplifier. To re-optimize the multi-carrier amplifier, the signal detector may distinguish between at least two types of carriers or two types of spread spectrum signals at varying transmit power level on one or more carriers. For example, in multi-carrier applications (i.e., a mixed RF input of voice and data), the amplifier may not be able distinguish between the two types of signals. To compensate for such problems, one approach involves adding more silicon which increases the cost of such solution. The signal detector may detect frequency components of incoming signals in the RF input 115 by analyzing residuals and sum of square errors (SSE) in the incoming signals. By determining the frequency components, the signal detector provides an indication that an idle mode high data rate (HDR) carrier is present at the RF input. A set of look-up tables with different carrier combinations may enable the curve fitting models to determine a desired bias condition and obtain higher power efficiency for the amplifier.

Accordingly, the signal detector may detect a combination of one or more carriers and determine a particular type of carrier and a particular type of the spread spectrum signal within a radio frequency (RF) input. To this end, the signal detector may detect a peak-to-average ratio by minimizing a sum of square errors (SSE) and maximizing a residual parameter of the combination of signals in the RF input. However, when the RF input changes to a power level of a first type of the spread spectrum signal (e.g., voice) or upon receiving a second type of the spread spectrum signal (e.g., HDR) other than first type of the spread spectrum signal (e.g., voice) or if receives another carrier with the second type of the spread spectrum signal, the signal detector may re-optimize the multi-carrier amplifier. In this way, the signal detector may enable the multi-carrier amplifier to distinguish between voice and data even if the RF input changes gradually. By re-optimizing the multi-carrier amplifier at a maximum power for that change of the power level of a type of the spread spectrum signal, the type of the spread spectrum signal and/or the change in the mixture or combination of first and second types of spread spectrum signals, the signal detector may reduce power consumption and provide a relatively higher efficiency.

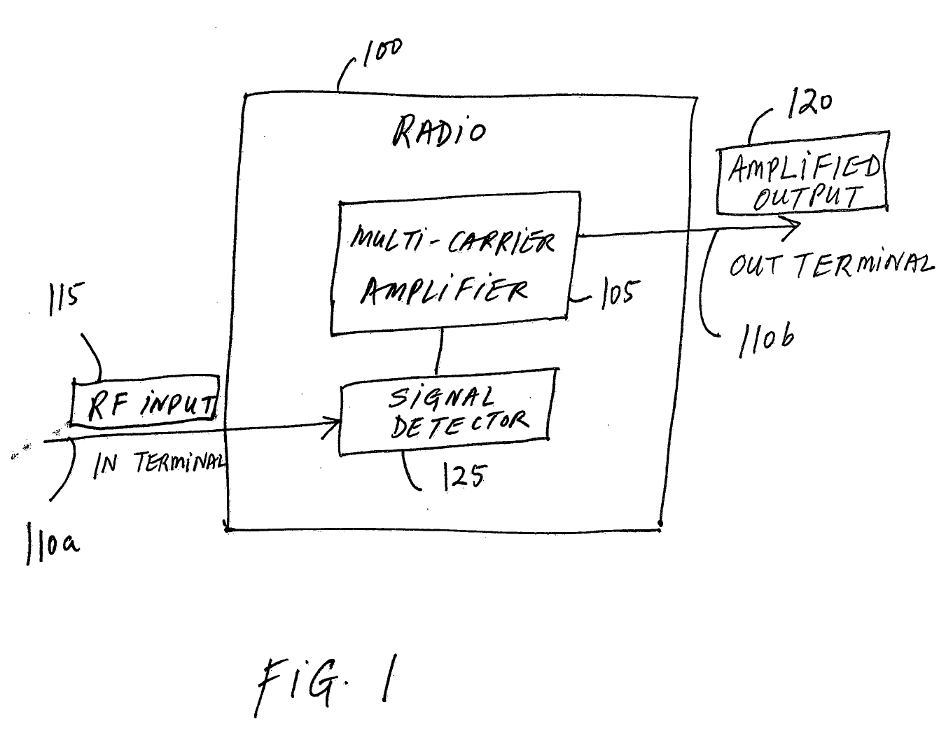

Referring to FIG. 1, a radio 100 is illustrated to include an amplifier, such as a multi-carrier amplifier 105 to amplify a wireless communication signal in accordance with one embodiment of the present invention. The radio 100 may comprise an in-terminal 110A and an out-terminal 110B. The in-terminal of the radio 100 may receive a radio frequency (RF) input 115. The multi-carrier amplifier 105 may provide an amplified output 120 at the out-terminal 110B.

The RF input 115 may comprise multiple types of carriers or multiple types of spread spectrum signals at varying transmit power level on one or more carriers such that a single carrier may carry voice and/or data over the RF input 115. The spread spectrum signals may be associated with voice or data based on a desired standard for a wireless communication system in which the radio 100 is deployed.

In one embodiment of the present invention, the RF input 115 may include a single carrier, a multi-carrier, a Code Division Multiple Access (CDMA) protocol based spread spectrum signal, a Universal Mobile Telecommunications System (UMTS) signal, or a high data rate (HDR) signal, such as compliant with Evolution Data Only, Evolution Data Optimized (1×-EVDO) standard signal. For example, a UMTS standard based RF input 115 may enable broadband, packet-based transmission of text, voice, video, and multimedia at data rates about and higher than 2 megabits per second, offering a variety of services to mobile computer and cell phone users. The 1×-EVDO standard based RF input 115 may enable a wireless radio broadband data protocol for a CDMA system including a CDMA2000 standard based system.

In one embodiment, the radio 100 may further comprise a signal detector 125 coupled to the multi-carrier amplifier 105 to detect the RF input 115 for amplification by the multi-carrier amplifier 105. Persons of ordinary skills in the art should appreciate that portions of the radio 100, including the signal detector 125 and the multi-carrier amplifier 105 may be suitably implemented in any number of ways to include other components using hardware, software or a combination thereof. Wireless communication systems are known to persons of ordinary skill in the art and so, in the interest of clarity, only those aspects of the radio 100 that are relevant to the present invention will be described herein. In other words, unnecessary details not needed for a proper understanding of the present invention are omitted to avoid obscuring the present invention.

In one embodiment, the radio 100 may be disposed in a base station (BS) of a digital cellular network. Alternatively, the radio 100 may be disposed in a mobile station (MS) capable of communicating with the digital cellular network. The radio 100 may transmit a spread spectrum signal associated with a cellular system in which a mobile station and/or a base station may use a single carrier, a multi-carrier, code division multiple access protocol (MC-CDMA) transmission.

Examples of the radio 100 include a wireless transmitter, such as deployed in a communications system to provide radio frequency communications. For example, a transmitter may include the radio 100 in the base station or the mobile station and spread voice and/or data in time and frequency domains. The spread spectrum signals may be associated with voice or data based on a desired standard for a wireless communication system in which the radio 100 is deployed.

According to one embodiment of the present invention, the radio 100 includes a broadband radio which may operate at 50 megahertz (MHz). The radio 100 may use the multi-carrier amplifier 105 in the front end of a transmitter (not shown) to dynamically distinguish one carrier from another carrier and a combination of voice and data on a single carrier for a mixture of different levels, numbers and/or types of spread spectrum signals present in the RF input 115. In one example, the carriers may be non-continuous/non-contiguous carriers. The signal detector 125 may detect a combination of one or more carriers and determine a particular type of carrier and a particular type of the spread spectrum signal within the RF input 115.

The multi-carrier amplifier 105 may amplify the RF input 115 comprising at least two different types of carriers or two different types of spread spectrum signals on a single carrier. The signal detector 125 may enable the multi-carrier amplifier 105 to distinguish between voice and data even if the RF input 115 changes gradually. In other words, by using the signal detector 125, the multi-carrier 105 may distinguish between two different types of spread spectrum signals in the RF input 115 which may include a single carrier, a multi-carrier, or a CDMA spread spectrum signal, a UMTS signal, or a 1×-EVDO signal.

In operation, the signal detector 125 may detect the type of the spread spectrum signal and determine a mixture of one or more spread spectrum signals within the RF input 115. By distinguishing the type of spread spectrum signal and determining a kind of mixture in which that type of spread signal is present within the RF input 115, the multi-carrier amplifier may re-optimize even if the RF input 115 changes after initial optimization across a full dynamic range of multiple types of disparate spread spectrum signals.

Accordingly, the signal detector 125 may detect a peak-to-average ratio of one or more spread spectrum signal in the RF input 115, i.e., for a mixture or combination of first and second types of spread spectrum signals. That is, the signal detector 125 may optimize the multi-carrier amplifier 105 for a power level associated with a first type of the spread spectrum signal based on the peak-to-average ratio. For example, the first type of the spread spectrum signal may be voice, while the second first type of the spread spectrum signal may be high rate data (HDR).

When the RF input 115 changes to the power level of the first type of the spread spectrum signal (e.g., voice) or upon receiving the second type of the spread spectrum signal other than first type of the spread spectrum signal (e.g., voice) or if receives another carrier with the second type of the spread spectrum signal (e.g., HDR), the multi-carrier amplifier may be re-optimized at a maximum power for that change of the power level of a type of the spread spectrum signal, the type of the spread spectrum signal and/or the change in the mixture or combination of first and second types of spread spectrum signals. The signal detector 125 may distinguish between different power levels or types of spread spectrum signals and another carrier of a spread spectrum signal to re-optimize the multi-carrier amplifier 105.

By detecting a change in a particular type of the spread spectrum signal, for example, if the voice is changed to data or vice-versa, and identifying a signal characteristic of the particular type of the spread spectrum signal, the signal detector 125 may optimize the multi-carrier amplifier 105 based on the change signal characteristic of the particular type of the spread spectrum signal having a different power level in the RF input 115.

In another embodiment, if the capacity of the radio 100 changes in response to a change in number of users which causes the transmit power associated with the spread spectrum signal in the RF input 115 to change, the multi-carrier 105 may optimize accordingly for a change in the transmit power level of the spread spectrum signals.

Thus, even if the RF input 115 may include a mixture of different levels, numbers and/or types of spread spectrum signals, such as voice and data, the multi-carrier amplifier 105 may adapt to such a change in the RF input 115. For example, the RF input 115 may include a first carrier for voice and a second carrier for data and when another carrier for data is detected by the signal detector 125, the multi-carrier amplifier 105 may optimize based on a new mixture of the spread spectrum signals which includes the second carrier for data. The signal detector 125 may determine a combination one or more carriers for voice and data that the multi-carrier amplifier 105 receives for amplification. By re-optimizing the multi-carrier amplifier 105, the signal detector 125 may reduce power consumption and provide a relatively higher efficiency. The signal detector 125 may distinguish the use of a first carrier for a first type of the spread spectrum signal and use of a second type of carrier for a second type of the spread spectrum signal.

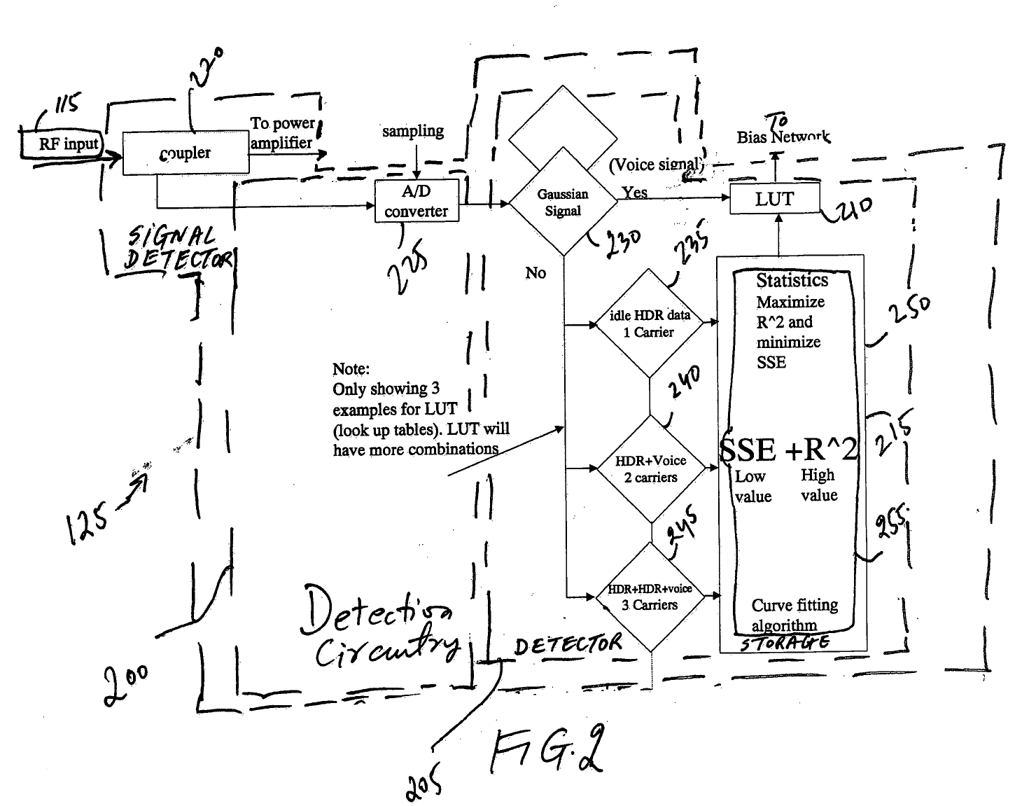

Referring to FIG. 2, the signal detector 125 shown in FIG. 1 is schematically illustrated in accordance with one embodiment of the present invention. The signal detector 125 may comprise detection circuitry 200 coupled to a detector 205 to detect one or more spread spectrum signals of first and second types in accordance with one embodiment of the present invention.

The detection circuitry 200 may identify at least two statistical characteristics of a type of spread spectrum signal for voice and/or data. In addition, the detection circuitry 200 may detect frequency components, i.e., a signal characteristic, of the incoming RF input 115. Based on the frequency components, the detector 205 may determine an indication of a signal characteristic of the spread spectrum signal to distinguish between the voice and data.

The detector 205 may further comprise a look-up-table 210 and a storage 215 coupled to the look-up-table 210 to store instructions for detecting the RF input 115 and for identifying different carriers and/or levels of the spread spectrum signals present in the RF input 115.

For distinguishing voice from data over a combination of different number of carriers present within the RF input signal 115, the signal detector 125 may comprise a coupler 220 that receives the spread spectrum signals in the RF input 115 for the detection circuitry 200 and for applying to a power amplifier (not shown).

Consistent with one embodiment, the detection circuitry 200 may comprise an analog-to-digital (A/D) converter 225 coupled to the coupler 220 to sample the RF input 115. The A/D converter 225 may sample a given minimum number of sampling points in a data and/or a voice signal within the RF input 115. The detector 205 may determine whether the RF input signal 115 includes a Gaussian signal, such as using a decision block 230. If a Gaussian signal detected, the detector 205 may indicate that the RF input 115 includes a voice signal. The voice signal may be forwarded to the look-up-table 210 to provide a desired bias to a bias network (not shown).

However, if at the decision block 230, the detector 205 determines that a Gaussian signal is not detected within the RF input 115, a first decision block 235 determines whether an idle mode of High Data Rate (HDR) is present. In particular, the decision block 235 determines whether a single carrier is present in the RF input 115 for a High Data Rate (HDR) signal. Likewise, a second decision block 240 may determine whether two carriers, one for High Data Rate (HDR) and another for voice are present in RF input 115. A third decision block 245 may indicate presence of three carriers including two High Data Rate (HDR) signals and voice signal.

According to one illustrative embodiment of the present invention, the storage 250 may stores an algorithm 255 for curve fitting. The algorithm 255 may store instructions for detecting a peak-to-average ratio of one or more of spread spectrum signals present in the RF input 115. To detect the peak-to-average ratio, the algorithm 255 may minimize a sum of square errors (SSE) and maximize a residual parameter.

More specifically, the algorithm 255 may analyze the sampling points from the A/D converter 225 and enable detection of the Gaussian signal at the decision block 230 for optimizing the multi-carrier amplifier 105 shown in FIG. 1. Based on a combination of one or more carriers determined by the decision blocks 235, 240 and 245, the algorithm 255 may form one or more curve fitting models. Although, only three decision blocks 235, 240 and 245 are shown for the look-up-table 210, persons of ordinary skill in the art would appreciate that a desired number of the decision blocks 235, 240 and 245 for determining combinations of carriers may be suitably provided based on a specific application.

To optimize a biasing condition of a data, such as High Data Rate (HDR) and/or voice signal in the incoming RF input 115 at the multi-carrier amplifier 105, the algorithm 255 may use one or more curve fitting models to provide a desired bias to the multi-carrier amplifier 105.

More specifically, the detector 205 may identify a change in the RF input signal 115 at different capacity levels. That is, the detector 205 may determine a number of spread spectrum signals present in a combination of multiple spread spectrum signals. Moreover, the detector 205 may detect transitions associated with one or two users on a single carrier within the RF input 115 to optimize the multi-carrier amplifier 105 based on the number of users. In this way, the detector 205 may optimize the multi-carrier amplifier 105 to a maximum power level and a maximum number of users.

Additionally, the detector 205 may optimize a bias condition associated with a bias current to suppress an undesired regrowth of current condition. That is, even if the current conditions may constantly change, instead of amplifying a signal based on various fixed ratios of peak-to-average power, the detector 205 may re-optimize the multi-carrier amplifier 105 in response to varying current conditions.

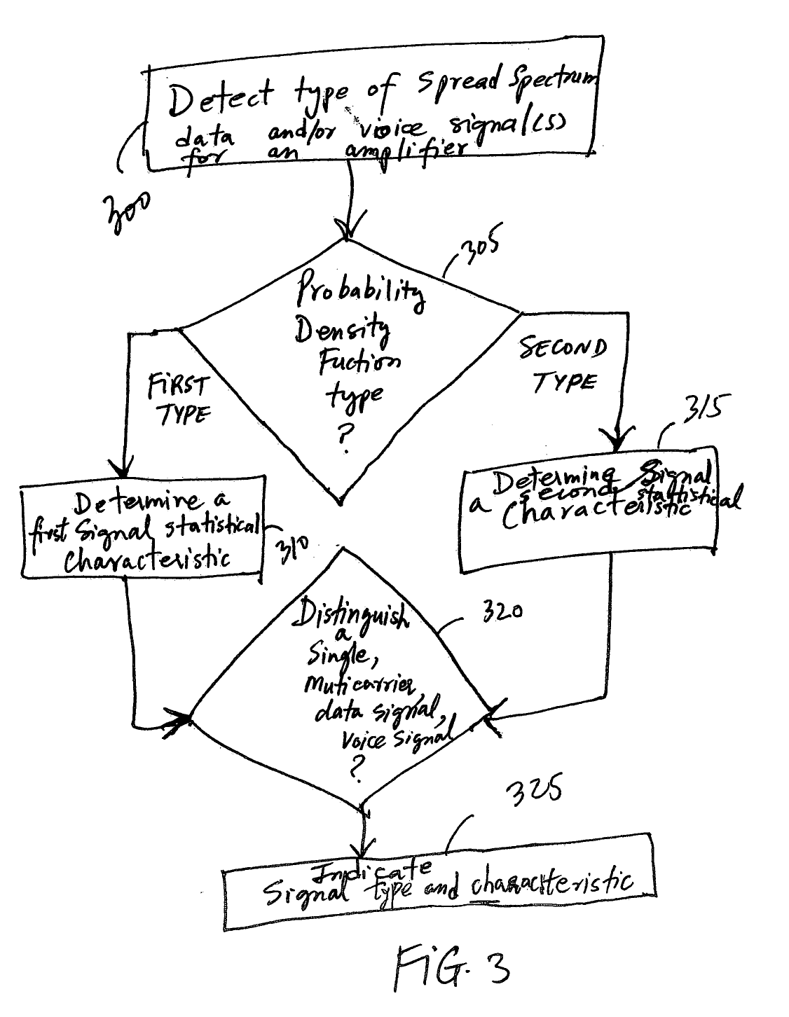

Referring to FIG. 3, a stylized representation for implementing a method of detecting and identifying one or more spread spectrum data and/or voice signals for the multi-carrier amplifier 105 is depicted in accordance with one embodiment of the present invention. To detect and identify a particular type of a spread spectrum signal, at block 300, the signal detector 125 may identify one or more statistical characteristics of the spread spectrum signal received in the RF input 115.

As illustrated in FIG. 3, a decision block 305 may determine a type of probability density function. A probability density function or a density function also sometimes called a frequency function refers to the statistical function that indicates distribution of the density of possible observations in a population of signal samples. If a first type of the probability density function is indicated at the decision block 305, at block 310, the signal detector 125 may determine a first signal statistical characteristic associated with a first type of spread spectrum signal, for example, data, such as High Data Rate (HDR). Conversely, if at the decision block 305, a second type of the probability density function is indicated at block 315, the signal detector 125 may determine a second signal statistical characteristic for the second type of probability density function associated with a second type of spread spectrum signal, such as voice.

A decision block 320 may distinguish a single, multi-carrier a data signal, a voice signal based on the first and second signal statistical characteristics. In this way, a signal carrier type and a signal characteristic may be indicated at block 325 by the signal detector 125. For example, the signal detector 125 may indicate presence of three carriers including two data signals and one voice signal.

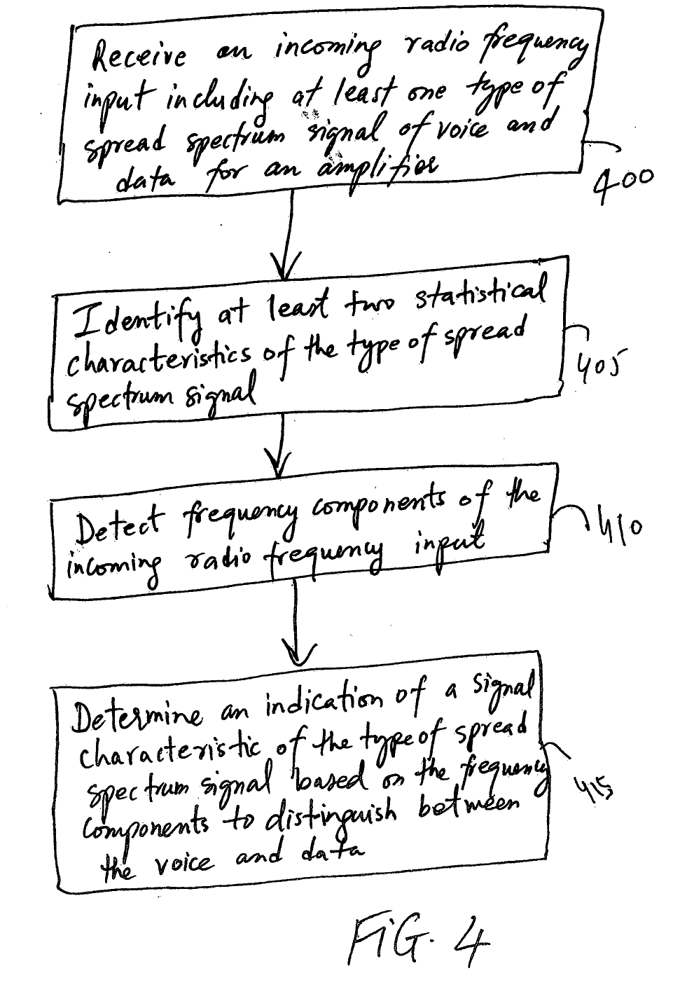

Referring to FIG. 4, a stylized representation for implementation of a method of distinguishing between voice and data signals for the multi-carrier amplifier 105 is illustrated in accordance with one embodiment of the present invention. At block 400, the detection circuitry 200 may receive the incoming RF input 115 including at least one type of spread spectrum signal of voice and data, such as High Data Rate (HDR). At block 405, the detector 205 may identify at least two statistical characteristics of the type of spread spectrum signal present in the RF input 115.

The detection circuitry 200 may detect frequency components of the incoming RF input 115 at block 410. Based on the frequency components, the detector 205 may determine an indication of a signal characteristic of the type of the spread spectrum signal to distinguish between the voice and data at block 415.

For the multi-carrier amplifier 105, the detector 205 may determine a bias point associated with a probability density function for a transmitted waveform that may comprise multiple spread spectrum signals. By using the bias point, the detector 205 may optimize a bias condition associated with the spread spectrum signals for the multi-carrier amplifier 105.

More particularly, the RF input 115 having an associated radio frequency (RF) power may comprise power associated with different signals, such as voice, high data rate (HDR), or both. While the HDR signals or carriers change characteristics such as transition from an idle mode to a full data mode or stage somewhere in between, the voice signals have a relatively low peak-to-average (PAR) ratio. In fact, the idle mode for HDR has a considerably high peak-to-average (PAR) ratio.

The detection circuitry 200 may determine a first peak-to-average (PAR) ratio of a first type of spread spectrum signal and a second PAR of a second type of spread spectrum signal for a wireless communication. Based on the first and second PAR ratios, the detector 205 may detect a high data rate (HDR) signal from the first and second types of the spread spectrum signals. In one embodiment, the detector 205 may compare the first PAR ratio of the first type of voice signal to a threshold PAR ratio associated with the second PAR ratio.

Since the peak-to-average (PAR) ratio of a transmitted waveform may determine the bias point and efficiency of the transmitted RF power for an amplifier, the detector 205 may distinguish between different signal waveforms received in the RF input 115 to optimize a biasing condition of HDR and/or voice for the multi-carrier amplifier 105. In this way, the detector 205 may increase the power efficiency while reducing spurious radio frequency (RF) emissions in a wireless communication system including a spread-spectrum cellular system.

Examples of the spread-spectrum cellular system comprising a set of base stations (BSs) and a plurality of mobile stations (MSs) that may provide a desired spreading of multiple types of signals for transmitting on an uplink (reverse) or a downlink (forward) using at least two carriers according to one illustrative embodiment of the present invention. Although no mobile stations, base stations and radio network controller are not shown in FIG. 1, persons of ordinary skill in the pertinent art having benefit of the present disclosure should appreciate that any desirable number of mobile stations, base stations and radio network controllers may be used.

The set of base stations may provide the wireless connectivity to at least one mobile station according to any desirable protocol. Examples of a protocol include a code division multiple access (CDMA, CDMA2000) protocol, wideband-CDMA (WCDMA) protocol, a Universal Mobile Telecommunication System (UMTS) protocol, a Global System for Mobile communications (GSM) protocol, and like.

Examples of the mobile stations may include a host of wireless communication devices including, but not limited to, cellular telephones, personal digital assistants (PDAs), and global positioning systems (GPS) that employ the spread spectrum cellular system to operate in a high-speed wireless data network, such as a digital cellular CDMA network. Other examples of the mobile stations may include smart phones, text messaging devices, and the like.

In the spread-spectrum cellular system, mobile communications that communicate messages between the set of base stations and each mobile stations may occur over an air interface via a wireless channel such as a radio frequency (RF) medium channel that uses a code division multiple access (CDMA) protocol. Although not shown, the wireless channel may include any intermediate devices that facilitate wireless communication between the mobile stations and the set of base stations. A radio network controller may coordinate mobile communications upon a user leaving an area of responsibility of one base station into another base station or when responsibility of communication switches from a first cell sector served by the base station to a second cell sector served by the other base station.

According to one illustrative embodiment of the present invention, in the spread-spectrum cellular system, the transmission may comprise packet data. In one embodiment, the mobile station may use a code division multiple access (CDMA) protocol, or a multi-carrier CDMA (MC-CDMA) radio access technique to communicate with the base station.

A transmitter in the spread spectrum wireless cellular system, consistent with one embodiment of the present invention, may use at least two carriers in a transmission. In one embodiment, time and and/or frequency spreading may apply to a specific frame structure, such as a frame format capable of using different sub channels. The portions of the transmission may be separated in temporal, spectral, and/or spatial domains for a wireless communication the base station and the mobile station.

To provide the desired spreading for transmitting data, the transmitter may use a spread-spectrum protocol and at least two carriers including a first carrier and a second carrier. One example of the first and second carriers is wireless channels that enable transmission of the data over an air interface between the base station and the mobile station.

A mobile station may transmit traffic packets, such as data packets in the transmissions. Often the traffic packets include information that is intended for a particular user of a mobile station. For example, traffic packets may include voice information, images, video, data requested from an Internet site, and the like.

In the spread spectrum cellular system, a wireless data network may deploy any desirable protocol to enable wireless communications between the base stations and the mobile stations according to any desirable protocol. Examples of such a protocol include a (CDMA, WCDMA) protocol, a UMTS protocol, a GSM protocol, and like. A radio network controller (RNC) may be coupled to the base stations to enable a user of the mobile station to communicate packet data over a network, such as a cellular network. One example of the cellular network includes a digital cellular network based on a CDMA protocol, such as specified by the 3rd Generation (3G) Partnership Project (3GPP) specifications.

Other examples of such a protocol include a WCMDA protocol, a UMTS protocol, a GSM protocol, and like. The radio network controller may manage exchange of wireless communications between the mobile stations and the base stations according to one illustrative embodiment of the present invention. Each of the base stations, sometimes referred to as Node-Bs, may provide connectivity to associated geographical areas within a wireless data network. Persons of ordinary skill in the art should appreciate that portions of such a wireless data network may be suitably implemented in any number of ways to include other components using hardware, software, or a combination thereof. Wireless data networks are known to persons of ordinary skill in the art and so, in the interest of clarity, only those aspects of a wireless data network that are relevant to the present invention will be described herein.

According to one embodiment, each mobile station may communicate with an active base station on a reverse link via the radio network controller coupled to the first and second base stations. An active base station, which is generally referred to as the serving base station or the serving sector may communicate over a forward link with the mobile station. The 3rd Generation Partnership Project (3GPP) standard defines the role of a serving base station or a serving sector and a serving radio network controller based on 3GPP specifications.

In one embodiment, the reverse link and the forward link may be established on a plurality of channels. The channels, such as traffic and control channels may be associated with separate channel frequencies. For example, CDMA channels with associated channel number and frequency may form a wireless communication link for transmission of high-rate packet data. On the forward link, for example, the mobile stations may update the base station with a data rate to receive transmissions on a Forward Traffic Channel or a Forward Control Channel. The Traffic Channel carries user data packets. The Control Channel carries control messages, and it may also carry user traffic. The forward link may use a Forward MAC Channel that includes four sub-channels including a Reverse Power Control (RPC) Channel, a Data Rate Control Lock (DRCLock) Channel, ACK channel and a Reverse Activity (RA) Channel.

On the reverse link, the mobile station may transmit on an Access Channel or a Traffic Channel. The Access Channel includes a Pilot Channel and a Data Channel. The Traffic Channel includes Pilot, MAC and Data Channels. The MAC Channel comprises four sub-channels including a Reverse Rate Indicator (RRI) sub-channel that is used to indicate whether the Data Channel is being transmitted on the Reverse Traffic Channel and the data rate. Another sub-channel is a Data Rate Control (DRC) that is used by the mobile station to indicate to a base station a data rate that the Forward Traffic Channel may support on the best serving sector. An acknowledgement (ACK) sub-channel is used by the mobile station to inform the base station whether the data packet transmitted on the Forward Traffic Channel has been received successfully. A Data Source Control (DSC) sub-channel is used to indicate which of the base station sectors should be transmitting forward link data.

In another embodiment, the transmission of packet data may be associated with at least two cell sectors associated with one or more of a set of base stations. In one embodiment, the spread-spectrum cellular system may be based on a cellular network, which at least in part, may be based on a Universal Mobile Telecommunications System (UMTS) standard. The cellular network may be related to any one of the 2G, 3G, or 4G standards that employ any one of the protocols including the UMTS, CDMA2000, or the like, however, use of a particular standard or a specific protocol is a matter of design choice and not necessarily material to the present invention.

In one embodiment, a conventional Open Systems Interconnection (OSI) model may enable transmission of the packet data and other data including messages, packets, datagram, frames, and the like between the mobile station and the set of base stations. The term “packet data” may include information or media content that has been arranged in a desired manner. The packet data may be transmitted as frames including, but not limited to, a radio link protocol (RLP) frame, signaling link protocol (SLP) frame or any other desired format. Examples of the packet data may include a payload data packet representative of voice, video, signaling, media content, or any other type of information based on a specific application.

In one embodiment, the spread-spectrum cellular system may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP2) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP2) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of detecting one or more of spread spectrum signals of two or more types having distinct statistical characteristics to identify a signal input to an amplifier having an input terminal, the method comprising:
in response to an indication of statistical characteristics associated with said one or more of spread spectrum signals at said input terminal of said amplifier, determining a signal characteristic of said signal input to associate said one or more of spread spectrum signals with one of said two or more types; and
distinguishing between said one or more of spread spectrum signals of said two or more types based on said statistical characteristics associated therewith.

2. A method, as set forth in claim 1, wherein determining said signal characteristic of said signal input further comprises:
detecting a peak to average ratio of said one or more of spread spectrum signals by minimizing a sum of square errors parameter and maximizing a residual parameter.

3. A method as set forth in claim 2, further comprising:
analyzing a given minimum number of sampling points;
detecting a Guassian signal; and
optimizing said amplifier based on said Guassian signal.

4. A method, as set forth in claim 3, further comprising:
determining a bias point from a probability density function associated therewith for a transmitted waveform including said one or more spread spectrum signals at said amplifier; and
optimizing a biasing condition associated with said one or more spread spectrum signals for said amplifier based on said bias point.

5. A method, as set forth in claim 1, wherein said one or more spread spectrum signal includes at least one type of voice signal and a high data rate signal.

6. A method, as set forth in claim 1, wherein said amplifier is a multi-carrier amplifier.

7. A method, as set forth in claim 1, further comprising:
providing signal detection circuitry that determines a first peak to average ratio of a first type of spread spectrum signal and a second peak to average ratio of a second type of spread spectrum signal for a wireless communication;
detecting a high data rate signal from said first and second types of said one or more spread spectrum signals based on said first and second peak to average ratios; and
comparing said first peak to average ratio of said at least one type of voice signal to a threshold peak to average ratio associated with said second peak to average ratio.

8. A method of detecting an input signal presented to an input terminal of an amplifier configured to detect signals of two or more types having distinct statistical characteristics, comprising:
obtaining a probability density function of the input signal;
determining a signal characteristic from said function to associate the input signal with one of said two or more types; and
using said statistical characteristics to distinguish a carrier used for said two or more types of said input signal.

9. A method, as set forth in claim 8, wherein the input signal is a spread-spectrum signal:

10. A method, as set forth in claim 8, wherein different probability density functions are used to associate the input signal with different signal types of said two or more types of said input signal

11. A method, as set forth in claim 8, wherein the input signal is a composite signal comprising component signals of at least two different types, and at least two component signals are associated with distinct, respective signal types of said two or more types of said input signal

12. A method of amplifying an incoming radio frequency input including at least one type of spread spectrum signal for voice and data, the method comprising:
identifying at least two statistical characteristics of said at least one type of spread spectrum signal;
detecting frequency components of said incoming radio frequency input; and
determining an indication of a signal characteristic of said at least one type of spread spectrum signal based on said frequency components to distinguish between said voice and data.

13. A method, as set forth in claim 12, further comprising:
using a look-up-table to determine whether a combination of one or more carriers is present in said incoming radio frequency signal.

14. A method, as set forth in claim 13, further comprising:
determining whether an idle mode data carrier is present in said incoming radio frequency input; and
forming one or more curve fitting models based on said combination of one or more carriers.

15. A method, as set forth in claim 14, further comprising:
providing a desired bias to an amplifier based on said one or more curve fitting models to optimize a biasing condition of at least one of data and voice signal in said incoming radio frequency input at said amplifier.

16. A signal detector for use with an amplifier to amplify an incoming radio frequency input including at least one type of spread spectrum signal for voice and data, the signal detector comprising:
detection circuitry to identify at least two statistical characteristics of said at least one type of spread spectrum signal and detect frequency components of said incoming radio frequency input; and
a detector coupled to said detection circuitry for determining an indication of a signal characteristic of said at least one type of spread spectrum signal based on said frequency components to distinguish between said voice and data.

17. A signal detector, wherein said detector comprises:
a look-up-table; and
a storage coupled to said look-up-table to store instructions for detecting a peak to average ratio of said one or more of spread spectrum signals by minimizing a sum of square errors parameter and maximizing a residual parameter, analyzing a given minimum number of sampling points, detecting a Guassian signal, optimizing said amplifier based on said Guassian signal, and forming one or more curve fitting models based on said combination of one or more carriers.

18. A signal detector, as set forth in claim 17, wherein said instructions to provide a desired bias to an amplifier based on said one or more curve fitting models to optimize a biasing condition of at least one of a data and voice signal in said incoming radio frequency input at said amplifier.

19. A signal detector, as set forth in claim 18, wherein said detection circuitry comprising:
a coupler to receive said incoming radio frequency input.

20. A signal detector, as set forth in claim 19, further comprising:
an analog-to-digital converter coupled to a coupler to sample a given minimum number of sampling points in said at least one of a data and a voice signal.
